(19) United States
(12) Patent Application Publication
(10) Pub. No.: US 2012/0197975 A1
(43) Pub. Date: Aug. 2, 2012

(54) Multi-channel context aware communication technology

(76) Inventors: Pierre Paul Samson, Lancaster (CA); Michel Prevost, Gatineau (CA); Francis Beaulieu, Montreal (CA)

(21) Appl. No.: 13/231,801

(22) Filed: Sep. 13, 2011

Related U.S. Application Data
(60) Provisional application No. 61/438,608, filed on Feb. 1, 2011.

(51) Int. Cl. G06F 15/16

(52) U.S. Cl. 709/203

(57) ABSTRACT

The present disclosure describes, among other things, a method. The method may include receiving a communication from a user through a first communication channel. The method may include matching the communication with a workflow based on a correlation between the workflow and an indicia associated with the first communication channel and the user. The method may include processing the communication according to a first step in the workflow.

### RELATED APPLICATIONS

This application claims priority to U.S. application No. 61/438,608, entitled “System for Bi-Directional Communication Across Multiple Communication Channels for a Workflow” and filed Feb. 1, 2011, the contents of which are hereby incorporated by reference in their entirety.

### BACKGROUND

Communication between customers and organizations may occur in a piecemeal fashion. Customers may send e-mails to the organization, visit the organization's website, and/or call the organization's customer service line. Organizations may send information to customer's e-mail addresses and/or call customers. Information about customers and the organizations may be lost between such communications.

### SUMMARY

In some aspects, the present disclosure is directed to a method. The method may include receiving a communication from a user through a first communication channel. The method may include matching, by a processor on a server, the communication with a workflow based on a correlation between the workflow and an indicia associated with the first communication channel and the user. The method may include processing the communication according to a first step in the workflow.

The indicia associated with the first communication channel and the user may be an e-mail address, a mobile phone number, a uniform resource locator (URL), an internet protocol (IP) address of a computing device, an identification number of a computing device, or an identifier associated with single sign-on (SSO).

The method may also include selecting a first communication channel from a plurality of communication channels in a user profile according to the first step in the workflow; and creating a correlation between the workflow and the indicia associated with the first communication channel and the user. Selecting a first communication channel may include configuring an interface according to the first step in the workflow, the interface being accessible via the first communication channel.

The method may also include receiving the user profile from a database of user profiles. The method may also include transmitting a communication to the user through the first communication channel according to the first step in the workflow. The method may also include transmitting a communication to the user through a second communication channel according to the first step in the workflow. The method may also include receiving a message with information about an event; creating a workflow based on the event; and transmitting a message regarding the processing of the communication from the user to a sender of the message with information about the event.

Creating a workflow may include loading a workflow definition file into a workflow manager. The method may also include deleting the correlation between the workflow and the indicia associated with the first communication channel and the user in response to a determination that remaining steps in the workflow do not use the first communication channel. Receiving a communication from a user may include receiving a communication from an aggregator.

In some aspects, the present disclosure is directed to a system. The system may include a processor; and a memory, the memory storing instructions that, when executed by the processor, cause the processor to: receive a communication from a user through a first communication channel; match the communication with a workflow based on a correlation between the workflow and an indicia associated with the first communication channel and the user; and process the communication according to a first step in the workflow.

The memory may also store instructions that, when executed by the processor, further cause the processor to: select the first communication channel from a plurality of communication channels in a user profile according to the first step in the workflow, and create a correlation between the workflow and the indicia associated with the first communication channel and the user. The memory may also store instructions that, when executed by the processor, further cause the processor to: receive a user profile from a database of user profiles. The memory may also store instructions that, when executed by the processor, further cause the processor to: transmit a communication to the user through the first communication channel or a second communication channel according to the first step in the workflow.

The memory may also store instructions that, when executed by the processor, further cause the processor to: receive a message with information about an event; create an instance of a workflow based on the event; and transmit a message regarding the processing of the communication from the user to a sender of the message with information about the event. The memory may also store instructions that, when executed by the processor, further cause the processor to: create an instance of the workflow by loading a workflow definition file. The memory may also store instructions that, when executed by the processor, further cause the processor to: delete the correlation between the workflow and the indicia associated with the first communication channel and the user in response to a determination that remaining steps in the workflow may not use the first communication channel.

In some aspects, the present disclosure is directed to a method. The method includes receiving a message with information about an event; creating a workflow based on the event; receiving a user profile from a database of user profiles; selecting, by a processor on a server, a first communication channel from a plurality of communication channels in the user profile according to a first step in the workflow; creating a correlation between the workflow and an indicia associated with the first communication channel and the user; receiving a communication from a user through the first communication channel; matching the communication from the first communication channel with the workflow based on the correlation between the workflow and the indicia associated with the first communication channel and the user; processing the communication from the first communication channel according to the first step in the workflow; selecting a second communication channel from the plurality of communication channels in the user profile according to a second step in the workflow; creating a correlation between the workflow and an indicia associated with the second communication channel and the user; and transmitting a communication according to the second step in the workflow to the user through the second communication channel.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIGS. 1-2 are block diagrams of exemplary systems for bi-directional communication across multiple communication channels for a workflow; and

FIG. 3 is a block diagram of an exemplary computing device that may be used in the systems of FIGS. 1-2;

FIG. 4 is a block diagram of an exemplary system of FIG. in communication with aggregators; and

FIG. 5 is a flow diagram of an exemplary method with bi-directional communication across multiple communication channels for a workflow.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

In general overview, the systems and methods of the present disclosure enable organizations to leverage different communication channels with a customer (e.g., individual, business partner, client, employee, enterprise client system, machine controlled by any of the above) to execute workflows effectively and efficiently. Customers (also referred to herein as “users”) may subscribe to a workflow platform service. When subscribing, customers may create user profiles. The user profiles may include the channels of communication through which the users consent to contact. For example, users may provide their mobile telephone numbers through which they consent to receive short message service (SMS) communications, landline telephone number through which they consent to receive interactive voice response (IVR) communications, e-mail addresses through which they consent to receive e-mail, identifiers for mobile computing device on which they consent to receive customized information on mobile applications, or any other information related to communication.

When an organization seeks to execute a workflow, the organization may send a request to the workflow platform. The workflow platform may associate all the users' communication channels with the executing workflow. Thus, the workflow platform may accomplish a task while leveraging different ways of communicating with customers.

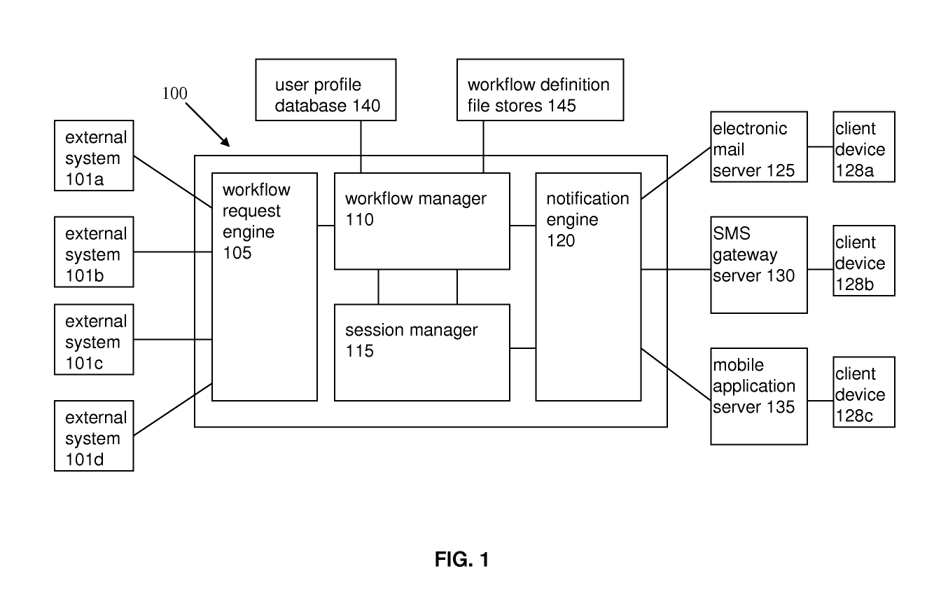

Referring now to FIG. 1, a system 100 (also referred to herein as a “workflow platform”) for communicating bi-directionally across multiple communication channels for a workflow is shown and described. The system 100 includes at least one processor and at least one memory. The at least one memory is configured to store instructions that, when executed, implement a workflow request engine 105, a workflow manager 110, a session manager 115, and a notification engine 120. The system 100 may communicate with external systems 101 to identify a workflow for execution and/or to create an instance of the workflow (also referred to herein as “workflow instance”). The system 100 may communicate with a user profile database 140 to obtain information about users. The system 100 may communicate with workflow definition file stores 145 to obtain information for creating instances of workflows for execution. The system 100 may communicate with client devices 128a, 128b, 128c (collectively 128) via entities 125, 130, 135 used on communication channels, while executing the workflow.

In operation, the workflow request engine 105 may receive a message from an external system 101. The workflow request engine 105 may transmit the message to the workflow manager 110. The workflow manager 110 may identify a user. In some implementations, the workflow manager 110 may parse the message to obtain an identification of a user. In some implementations, the workflow manager 110 may retrieve information about the user. For example, the workflow manager 110 may communicate with a user profile database 140 to retrieve the user's profile. In some implementations, a user profile may include the user's name and information about communication channels to which the user has consented (e.g., e-mail, short message service or “SMS,” mobile application, mobile site, interactive voice response/IVR, Voice over Internet Protocol/VoIP, Wifi tagging, radio frequency identification/RFID mediums). The user profile may include indicia of the communication channels to which the user has consented (e.g., e-mail address; mobile telephone number; uniform resource locator (URL); internet protocol (IP) address of a computing device; identification number of a computing device; identifier associated with single sign-on (SSO); identifier associated with an identification scheme such as OpenID, Facebook ID, Twitter ID, or Google ID).

The workflow manager 110 may identify a workflow for execution based on the message. In some implementations, the message from the external system 101 may identify the workflow. For example, the message may include a request to execute a workflow with a specified identification number. In some implementations, the workflow manager 110 may analyze the message to select the workflow. For example, the message may identify an event. The workflow manager 110 may select the workflow according to the event.

In some implementations, the workflow manager 110 may obtain one or more workflow definition files associated with the workflow. The workflow manager 110 may obtain the files from a workflow definition file store 145 (e.g., HTTP servers, REST servers, file systems, FTP servers, web-based distributed authoring and versioning (WebDAV) servers).

In some implementations, the workflow manager 110 may analyze the workflow against the user profile to determine if a workflow instance should be created for execution. In some implementations, the workflow manager 110 may analyze the first step of the workflow. The first step may require communication with a user through a specified communication channel. The workflow manager 110 may determine, based on the user profile, that the user has not consented to communication on the specified channel (e.g., the user profile does not include a mobile telephone number). The workflow manager 110 may determine the workflow cannot be performed. In some implementations, the workflow manager 110 may send a message indicating the workflow cannot be performed to the workflow request engine 105. The workflow request engine may send the message to the external system 101 that requested the workflow.

In some implementations, the workflow manager 110 may analyze each step in the workflow. The workflow manager 110 may determine one or more steps that require communication on specified channels. The workflow manager 110 may compare the specified channels against the communication channels in the user profile. If the user profile does not include one or more of the specified communication channels, the workflow manager 110 may determine the workflow cannot be performed. In some implementations, the workflow manager 110 may send a message indicating the workflow cannot be performed to the workflow request engine 105. The workflow request engine may send the message to the external system 101 that requested the workflow.

In some implementations, the user profile may include all the communication channels specified by the workflow steps. The workflow manager 110 may create the workflow instance. The workflow instance may include an identifier, such as an identification number. In some implementations, the workflow manager 110 may use parameters from the message from the external system 101 when creating the instance. Exemplary parameters include the periods of time for each step of the workflow in which the user must respond to communication, the addresses that shall receive the responses, and/or the requirement for a read-receipt regarding a communication.

In some implementations, the workflow manager 110 may send the identifier and the user profile to the session manager 115. The session manager 115 may correlate the workflow instance with the indicia of the communication channels to which the user has consented. For example, the session manager 115 may correlate the identification number of a workflow instance with a user's e-mail address, mobile telephone number, mobile devices, or any combination thereof The session manager 115 may create a log for the workflow instance. In some implementations, the session manager 115 may associated the workflow instance with a predetermined period of time before the workflow instance expires.

The workflow manager 110 may execute the workflow instance. In some implementations, a step of the workflow instance may require communication with the user. In some implementations, the step may specify the communication channel to be used. For example, the step may include sending an SMS message to the user's mobile telephone number. In some implementations, the step may specify alternative communication channels that may be used. In some implementations, the step may prioritize one communication channel over another. For example, the step may include sending an SMS message to the user's mobile telephone number if the user's mobile telephone number is provided in the user profile. If the user's mobile telephone number is not available, the step may alternatively include sending an e- mail message to the user's e-mail address.

The workflow manager 110 may send an instruction to the notification engine 120. The instruction may include the message to send to the user, based on the step in the workflow instance. The instruction may include the communication channel through which the message shall be sent. The instruction may include the indicia associated with the user for the communication channel. The notification engine 120 may process the instruction. The notification engine 120 may communicate with a third-party service (e.g., electronic mail server 125, SMS gateway server 130, mobile application server 135) to send the user the message through the specified communication channel. The user may access the message on a client device 128.

In some implementations, the workflow manager 110 may send the instruction to the session manager 115. The session manager 115 may log an entry for the workflow instance corresponding to the instruction.

In some implementations, a step of the workflow instance may require receipt of communication from the user. In some implementations, the notification engine 120 may receive a message from a third-party service, such as an electronic mail server 125, SMS gateway server 130, or mobile application server 135, although servers associated with any of the communication channels described herein may also be used. The notification engine 120 may send the message to the workflow manager 110 and/or the session manager 115. The session manager 115 may parse the message to determine the indicia of the communication channel, corresponding to the source of the message. The session manager 115 may identify one or more workflow instances correlated with the indicia. The session manager 115 may send the one or more workflow instance identifiers and the received message to the workflow manager 110. The session manager 115 may log an entry for the workflow instance corresponding to the communication received from the user.

The workflow manager 110 may process the received message according to the step in the workflow instance. The workflow manager 110 may continue to execute the steps in the workflow. In some implementations, when the session manager 115 completes execution of the workflow instance, the session manager 115 may determine one or more results of the instance. The session manager 115 may instruct the workflow request system 105 to send the result(s) to the external system 101 that requested the workflow. In some implementations, the session manager 115 may store the identifier of the workflow instance and/or result(s) of the executed instance for future retrieval for external systems 101.

In some implementations, one or more engines of the system 100 may execute on an application server. All the engines may execute on the same server. In some implementations, some of the engines execute on one server, while other engines execute on different servers. In some implementations, more than one server may execute any engine of the system 100. In some implementations, the engines may execute on one or more Java application servers. In some implementations, the engines may execute on any version of the WebSphere Application Servers, as manufactured by International Business Machines of Armonk, N.Y.

In some implementations, any of the engines described herein may be implemented as Java classes. In some implementations, the workflow manager 110 creates additional engines needed for a workflow instance upon creation of the instance itself In some implementations, the workflow manager 110 may include a Drools 5 product, manufactured by Apache.

In some implementations, the session manager 115 may store information about correlations between workflow instances and indicia of communication channels in a relational database of a relational database management system (RDBMS). In some implementations, the session manager 115 may store logs of workflow instances in a relational database. The session manager 115 may interact with a persistence layer to store the information. In some implementations, the session manager 115 may communicate with the persistence layer via a Java Persistence API (JPA), such as Hibernate. The persistence layer may communication with one or more relational databases via Java DataBase Connectivity (JDBC). Exemplary relational databases may be DB2 V9, provided by International Business Machines of Armonk, N.Y.

In some implementations, the notification engine 120 may include a message queuing system. The message queuing system may include send queues (e.g., prioritized send queues) that store messages to be sent to users. The message queuing system may include the receive queues that store messages received from users. In some implementations, the message queuing system may be WebSphere MQ, manufactured by International Business Machines of Armonk, N.Y. In some implementations, the message queuing system may be SIBus (e.g., a default message queuing system used by the WebSphere Application Server.

In some implementations, the system 100 may communicate with users who form at least part of a mobile workforce. In some implementations, the system 100 may connect with computing devices via Wifi or radio frequency identification (RFID). In some implementations, the system 100 may be leveraged for business-to-business communications and/or transactions.

In some implementations, external systems 101 may be legacy systems, content management system (CMS), customer relationship management (CRM) systems, supply chain management (SCM) systems, enterprise resource planning (ERP) systems, portals, enterprise systems, or any other system as would be appreciated by one of ordinary skill in the art.

In some implementations, the messages that external systems 101 send to the system 100 may be in any format. For example, a message may be in a comma-separated values (CSV) format. In another example, a message may have an American Standard Code for Information Interchange (ASCII) format. In another example, a message may have an Extensible Markup Language (XML) format.

In some implementations, an external system 101 may interact with the system using the hypertext transfer protocol (HTTP). In some implementations, a message an external system 101 sends to the system 100 requesting execution of a workflow may conform to the Simple Object Access Protocol (SOAP). In some implementations, a message an external system 101 sends to the system 100 requesting the result(s) of an executed workflow may conform to the Representational State Transfer (REST) protocol.

In some implementations, the workflow request engine 105 may interact with external systems 101 through a workflow integration layer (not shown), such as an enterprise workflow intergration layer. The external systems 100 may interface with the workflow integration layer via web services, or other non-intrusive systems. In some implementations, an external system 101 may be an external client enterprise system. The external client enterprise system may send a message with an event to the workflow integration layer via invoking a service associated with the workflow integration layer, by way of example. The workflow integration layer may send the message to the workflow request engine 105. In some implementations, the workflow request engine 105 may receive a result of an executed workflow instance and/or information in a communication from a user received from a client device 128. The workflow request engine 105 may invoke a service associated with the workflow integration layer to transmit the information to the external system 101.

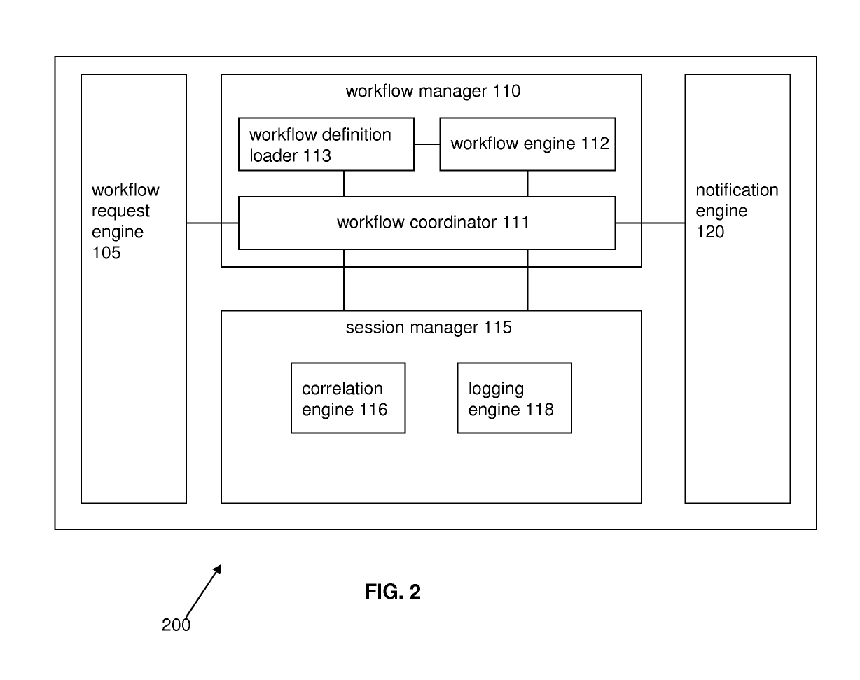

Referring now to FIG. 2, the system 200 for communicating bi-directionally across multiple communication channels for a workflow is shown and described in further detail. The system 200 includes at least one processor and at least one memory. The at least one memory is configured to store instructions that, when executed, implement a workflow manager 110 with a workflow coordinator 111, workflow engine 112, and/or workflow definition loader 113. The at least one memory is configured to store instructions that, when executed, implement a session manager 115 with a correlation engine 116, and/or logging engine 118.

In some implementations, the workflow coordinator 111 may manage communication between the other engines. For example, the workflow coordinator 111 may receive a communication from a user from the notification engine 120. The workflow coordinator 111 may send the communication to the session manager 115 to correlate to a workflow instance. The session manager 115 may send the instance's identifier to the workflow coordinator 111. The workflow coordinator 111 may send the identifier and the communication to the workflow manager 110. In another example, as the workflow manager 110 executes a workflow instance, the workflow manager 110 may send the instance's identifier and information about communications sent to users to the workflow coordinator 111. The workflow coordinator 111 may send the identifier and information to the session manager 115 for recordation in the instance's log.

In operation, the workflow definition loader 113 may communicate with the workflow definition file store(s) 140 to obtain workflow definition files. After receiving the identifier of a workflow from the workflow coordinator 111, the workflow definition loader 113 may retrieve from memory one or more files identifying the location(s) of workflow definition files for the workflow. In some implementations, the loader 113 may retrieve an XML file with the identifier of the workflow, the URLs of the file store 145 with the workflow definition files, and the URLs of the files. Using the URLs, the loader 113 may request the files from a file store 145. The loader 113 may load the files into the workflow engine 112 for execution.

In some implementations, the workflow definition files may be Drools flow and rule files, as developed by Red Hat, Inc. of Raleigh, N.C. In some implementations, the workflow definition files may describe a workflow using business process modeling notation (BPMN). In some implementations, the files may be created using any business rule management system (BRMS) as would be appreciated by one of ordinary skill in the art.

In some implementations, the loader 113 or the workflow engine 112 may store one or results of executed workflow instances in the workflow definition file stores 145. The loader or engine 112 may send the instance's identifier and result(s) to the file store 145. In some implementations, the result(s) may be stored with the workflow definition files.

In operation, the workflow engine 112 may execute an instance of a workflow. In some implementations, the engine 112 may execute multiple workflow instances. One or more of the workflow instances may be created and executed based on the same workflow, e.g., the workflow engine 112 may use the same workflow definition files to create the instances. The workflow engine 112 may distinguish between the instances based on, e.g., their identifiers.

In some implementations, the workflow manager 110 may use asynchronous messaging. For example, executing a step in a workflow instance may require information to be provided by a user. Until the user transmits such information to the workflow engine 112, further execution of the workflow instance may be stalled. In some implementations, the workflow instance may enter an interruptible blocking state as the instance waits for a communication with needed information to arrive. The workflow engine 112 may place the workflow instance in a queue. When information needed for a workflow instance is received, the workflow engine 112 may retrieve the workflow instance from the queue and continue executing the workflow instance. The workflow instance may process the information synchronously at specific steps within the workflow.

In some implementations, the notification engine 120 may receive the communication from the user with the information for a workflow instance. However, the workflow engine 112 may be processing a different workflow instance. The notification engine 120 and/or the workflow engine 112 may place the communication in a communication queue. The workflow engine 112 may complete processing of the different workflow instance and/or place the different workflow engine in a workflow instance queue until receipt of further information for that instance is received. The workflow engine 112 may retrieve the communication from the communication queue and the workflow instance corresponding to the communication. The workflow engine 112 may continue execution of the workflow instance corresponding to the received communication.

In some implementations, the workflow manager 110 may place a received communication in a communication processing queue. The workflow manager 110 may place multiple communications in the processing queue. In some implementations, system 100 may include multiple communication processing queues, each queue corresponding to a workflow instance.

In some implementations, the workflow manager 110 may deliver a communication to multiple workflow instances. For example, the workflow coordinator 111 may place a received communication in the communication processing queues for multiple workflow instances. The workflow coordinator 111 may place a communication in multiple processing queues according to correlations between workflow instances and an indicia associated with the communication channel through which the communication was received. For example, a user's mobile phone number, e-mail address, or other indicia may be correllated with more than one workflow instance. The workflow coordinator 111 may place a communication from a user's mobile phone in processing queues for the workflow instances, by way of example. In some implementations, workflow instances may discard communications whose information would not be processed as part of their respective workflows.

In some implementations, the workflow engine 112 may create and/or invoke additional engines (not shown) in the course of executing the workflow instance. For example, the workflow engine 112 may determine that a step in the workflow instance requires use of a particular engine. The processor(s) executing the workflow engine 112 may access memory to retrieve instructions that, when executed, implement the particular engine. Exemplary engines may include engines for communication and engines for specialized functions, although other engines may be used.

In some implementations, a communication engine may enable communicate with a user via short messaging services (SMS), multimedia messaging service (MMS), electronic mail (also referred to herein as “e-mail”), mobile application, and other communication channels described herein. For example, a communication engine may create a message to be sent to a user via SMS. The engine may conform the message to the protocol for SMS, e.g., the Mobile Application Part (MAP) of the SS7 protocol. The engine may send the message to the service provider associated with the user's mobile phone number. In some implementations, the engine may send the message to an aggregator 205, which determines the service provider associated with the mobile phone number and sends the message to that service provide.

In some implementations, a communication engine may be a geolocation engine. A geolocation engine may communicate with at least one of the user's mobile computing devices and/or their associated service providers to obtain the user's geolocation (e.g., latitudinal and longitudinal coordinates). For example, the geolocation engine may request the location of the user's mobile phone from the phone itself. The mobile phone may include a global positioning system (GPS) service. The mobile phone may communicate with the GPS service to obtain its geolocation. The mobile phone may transmit the geolocation provided by the GPS service to the geolocation engine on the system 200. The geolocation engine may send the geolocation to the workflow engine 112 to process in the course of executing a workflow instance step.

In some implementations, a communication engine may be an interactive voice response (IVR) engine. The IVR engine may receive an audio file created by one of the user's devices. The IVR engine may apply a speech recognition algorithm to the audio file. The algorithm may convert the audio signals on the file to text. The IVR engine may send the contents of the text to the workflow engine for processing in the course of executing a workflow instance step.

In some implementations, a specialized engine may interpret barcodes. For example, using a digital camera on a mobile telephone, a user may capture an image of a barcode for a product. The user may transmit the image to the system 200. The workflow engine 112 may be expecting an image with a barcode, due to the current step of the workflow instance. When the workflow engine 112 receives the image, the workflow engine 112 may invoke a barcode engine and send the image to the barcode engine. In some implementations, the barcode engine may process the image to identify a product. The barcode engine may transmit the identity of the product to the workflow engine 112.

In some implementations, a specialized engine may process a payment. For example, the workflow engine 112 may receive instructions from a user to make or receive a payment. The instruction may include the amount for the payment. In some implementations, the instruction may include the routing and account numbers for the user's bank account from which the payment amount should be debited. In some implementations, the instruction may include a credit card number and expiration date to which the payment amount should be charged. In some implementations, the payment engine may send payment information to a third-party vendor to fulfill a transaction. In some implementations, the payment engine may identify the financial institution associated with the bank account or credit card. The payment engine may communicate with the financial institution to process the payment.

In some implementations, the workflow engine 112 may halt execution of a workflow instance. The workflow engine 112 may delete the workflow instance. The workflow engine 112 may send a message indicating the workflow instance has been aborted to the external system 101 that requested the workflow instance. In some implementations, the workflow engine 112 may abort a workflow in response to an instruction from an external system 101 to do so.

In some implementations, the workflow engine 112 may create correlations between a workflow instance and an indicia of a communication channel associated with a user. The workflow engine 112 may send information about the correlations to the session manager 115. In some implementations, the workflow engine 112 may use a specialized component, such as a work item (e.g., a pre-defined structure of work which answers to a requirement of the workflow instance).

In some implementations, the correlation engine 116 may create correlations between workflow instances and indicia of communication channels for a user. In some implementations, the correlation engine 116 may correlate a workflow instance with an indicia by storing the identifier of the instance with the indicia in memory. For example, the correlation engine 116 may maintain a table of workflow instances. The correlation engine 116 may create an entry in the table for an instance. The entry may be accessed by the instance's identifier. The correlation engine 116 may populate fields in the entry with the indicia of communication channels in the user profile. In this manner, each instance of a workflow may be associated with multiple indicia for a user.

In another example, the correlation engine 116 may store a table of indicia in memory. The correlation engine 116 may search the table for the user's indicia. If the indicia is found in table, the correlation engine 116 may add the identifier of the workflow instance to the indicia's entry. If the indicia is not found in the table, the correlation engine 116 may create an entry for the indicia and store the workflow instance's identifier in association with the indicia. In this manner, indicia may be associated with multiple workflow instances.

The correlation engine 116 may receive a communication received from a user. Based on an indicia of a communication channel through which the communication was received, the correlation engine 116 may determine the workflow instance corresponding to the communication.

In operation, the logging engine 118 may create a log of events for the workflow instance. When the session manager 115 receives the identifier of a workflow instance and the indicia (e.g., information from the user profile) for correlation, the logging engine 118 may log (e.g., record a entry for) a start time corresponding to the receipt of the instance's identifier. In some implementations, the workflow engine 112 sends the session manager 115 the time the workflow instance was created. The logging engine 118 may use the provided time as the time of the instance's creation.

In some implementations, the logging engine 118 may record entries regarding communications sent to users by the workflow engine 112 and communications received from users. In some implementations, the workflow engine 112 may send to the session manager 115 a copy of each communication to be sent to a user. The logging engine 118 may log an entry for the workflow instance corresponding to the communication. In some implementations, the entry may include the contents of the communication, the communication channel used (e.g., e-mail, SMS, other channels described herein), the indicia of the communication channel (e.g., e-mail address, mobile telephone number, other indicia described herein), the time the instruction was sent, and/or any other information.

In some implementations, the logging engine 118 may log an entry corresponding to each communication received from the notification engine 120. The entry may include the time the communication was received, the contents of the communication, the type of the communication channel used (e.g., e-mail, SMS), the indicia of the communication channel (e.g., e-mail address, mobile telephone number), and/or any other information.

In some implementations, the logging engine 118 may record an end time for the workflow instance. The workflow engine 112 may send the session manager 115 a message when the workflow instance has been completed. The message may include the instance's identifier, the time of completion, one or more results of the workflow instance, and/or any other information. The logging engine 118 of the session manager 115 may record an entry including any of the information in the message. In some implementations, the workflow engine 112 may send the session manager 115 a message indicating that the workflow instance is being aborted. The logging engine 118 of the session manager 115 may record an entry including the instance's identifier, the time the message was received, an indication (e.g., a flag) that the instance was aborted, and/or any other information. In some implementations, the entry may include the reason the instance was halted.

In some implementations, the logging engine 118 may store the log of the workflow instance. In some implementations, the logging engine 118 may store each entry as an entry is created. In some implementations, the logging engine 118 may store all entries for a workflow instance after the instance completes execution. Thus, such storage enables future retrieval of the results and/or events of the workflow instance. For example, an external system 101 may retrieve results from workflows that the system 101 requested. In another example, if one or more system 100 components fail (e.g., the server executing the workflow engine crashes), the system 100 may retrieve information about the workflow instance to resume execution once such components have been restored.

In some implementations, the logging engine 118 may send the entries of the log to the workflow engine 112 or loader 113 for storage in a workflow definition file store 145. In some implementations, the logging engine 118 may store the entries of the log in one or more memories on the system 100.

In some implementations, the session manager 115 may create and/or invoke additional engines (not shown). The processor(s) executing the session manager 115 may access memory to retrieve instructions that, when executed, implement one or more administrative engines. In some implementations, an administrative engine may manage system 100 resources during execution of a workflow instance. For example, the administrative engine may delete correlations between workflow instances and indicia of communication channels associated with users.

The administrative engine may receive an instruction to delete a correlation between a workflow instance and an indicia of a communication channel associated with a user (e.g., a user's mobile phone number). In some implementations, the administrative engine may receive the instruction if the workflow engine 112 determines that a communication channel will not be used in remaining steps of the workflow instance. A correlation may be deleted by removing an indicia of a communication channel from an entry for the workflow instance in a table of workflow instances.

The administrative engine may receive an instruction to delete all correlations for a workflow instance. In some implementations, the administrative engine may receive the instruction if the workflow engine 112 has completed execution of the instance. Correlations for a completed workflow instance may be deleted by deleting the entry corresponding to the workflow instance from the table of workflow instances.

In some implementations, the receive dispatch engine may receive a communication from a user. The receive dispatch engine may receive the communication from a receive queue of messages. In some implementations, the receive dispatch engine may send the communication to the correlation engine 116 of the session manager 115 to determine the workflow instance corresponding to the communication. In some implementations, the receive dispatch engine may send the communication to a workflow coordinator 111, and the workflow coordinator 111 may send the communication to the correlation engine 116. In some implementations, the receive dispatch engine may include a Java class, such as a Message Driven Bean.

The systems, software, and methods described herein may be implemented advantageously in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object oriented programming language, or in assembly or machine language if desired. In any case, the language may be a compiled or interpreted language. Suitable processors include, by way of example, both general and special purpose microprocessors. Generally, a processor (e.g., one or more processors) will receive instructions and data from a read-only memory and/or a random access memory. Generally, a computer will include one or more mass storage devices for storing data files, such devices include magnetic disks, such as internal hard disks and removable disks magneto-optical disks and optical disks. Storage devices suitable for tangibly embodying computer program instructions and data include all forms of non-volatile memory, including, by way of example, semiconductor memory devices, such as EPROM, EEPROM, and flash memory devices; magnetic disks such as, internal hard disks and removable disks; magneto-optical disks; and CD ROM disks. Any of the foregoing may be supplemented by, or incorporated in, ASICs (application-specific integrated circuits).

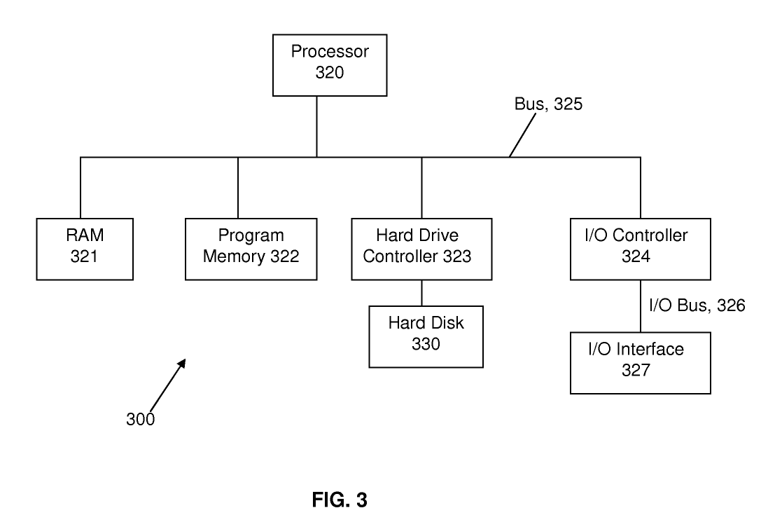

An example of one such type of computer is shown in FIG. 3, which shows a block diagram of a programmable processing system (system) 300 suitable for implementing or performing the apparatus or methods described herein. The system 311 includes a processor 320, a random access memory (RAM) 321, a program memory 322 (for example, a writeable read-only memory (ROM) such as a flash ROM), a hard drive controller 323, and an input/output (I/O) controller 324 coupled by a processor (CPU) bus 325. The system 311 may be preprogrammed, in ROM, for example, or it can be programmed (and reprogrammed) by loading a program from another source (for example, from a floppy disk, a CD-ROM, external disk drive, USB key, or another computer).

The hard drive controller 323 may be coupled to a hard disk 330 suitable for storing executable computer programs, including programs embodying the present methods, and data including storage. The I/O controller 324 may be coupled by an I/O bus 326 to an I/O interface 327. The I/O interface 327 may receive and transmit data in analog or digital form over communication links such as a serial link, local area network, wireless link, and parallel link.

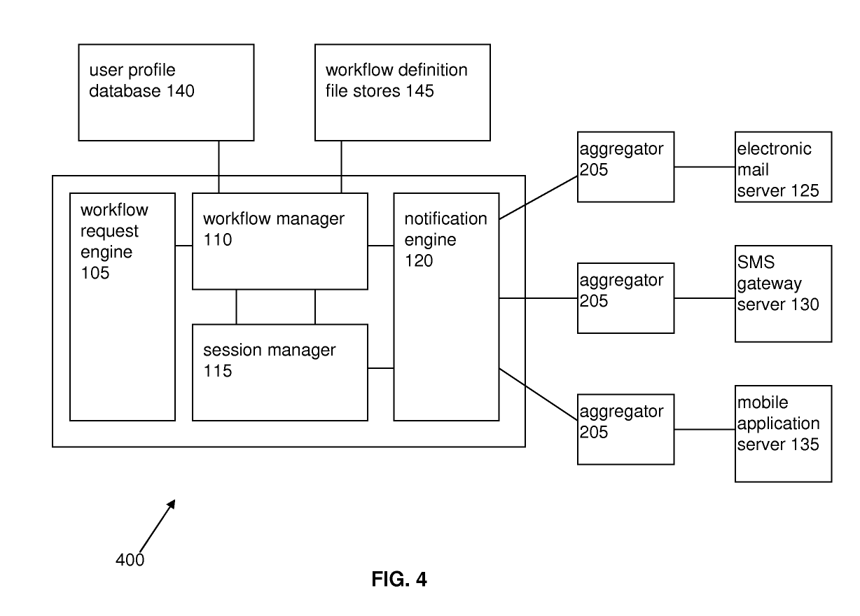

Referring now to FIG. 4, a system 400 for communicating bi-directionally across multiple communication channels for a workflow is shown and described. The system 400 may include the components described in reference to system 100 of FIG. 1. In the course of the workflow manager 110 executing a workflow instance, the notification engine 120 may communicate with one or more aggregators 205a, 205b, 205c (collectively, 205). The notification engine 120 may send a message for a user to an aggregator 205. In some implementations, the notification engine 120 may communicate with an aggregator 205 via hypertext transfer protocol (HTTP), Short Message Peer-to-Peer (SMPP) protocol, OneAPI, or any other protocol.

The aggregator 205 may evaluate the message to obtain the indicia for the communication channel associated with the user and/or the service provider associated with the indicia. For example, the aggregator 205 may evaluate a message to obtain a mobile telephone number. The aggregator 205 may determine that the mobile telephone number is associated with Verizon Communications, Inc. In another example, the aggregator 205 may evaluate a message to obtain an e-mail address. The aggregator 205 may determine the e-mail address is associated with Yahoo! Mail. The aggregator 205 may direct the message to the identified service provider for delivery to the user.

In some implementations, an aggregator 205 may limit the number of messages received from the notification engine 120. The limit may be a number of messages within a predetermined period of time. The limit may correspond to a capacity of the aggregator 205.

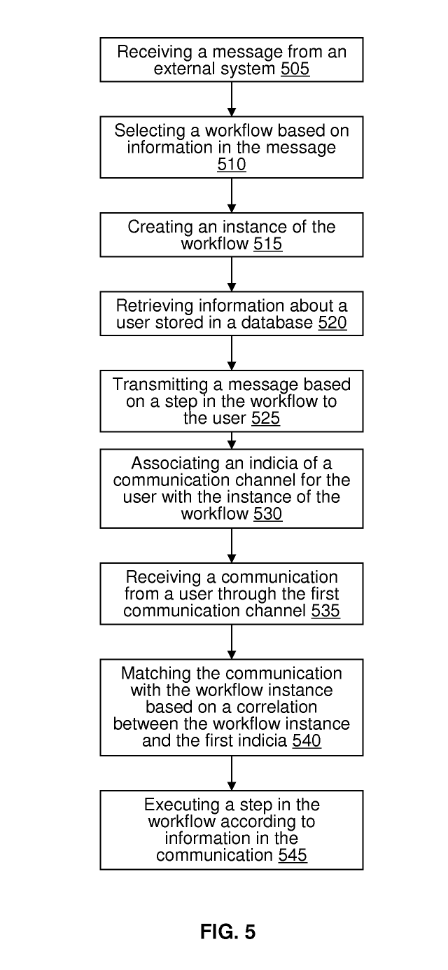

Referring now to FIG. 5, an exemplary method for communicating bi-directionally across multiple communication channels for a workflow is shown and described. Although the method may, in some implementations, be executed by the system 100 described in reference to FIG. 1, other systems capable of executing the method may be used. Although the steps of the method are described herein in a particular order, in some implementations, steps may occur in a different order and/or occur simultaneously.

In some implementations, the method includes receiving a message (step 505). The message may be received from an external system (e.g., CRM system, ERP system). The message may be received over a network, such as the Internet. The message may be received according to a protocol (e.g., hypertext transfer protocol (HTTP), Simple Object Access Protocol (SOAP)).

The message may include an identification of the external system sending the message. For example, the message may include the external system's client number for the system's 100 services. The message may include an identification of a user (e.g., user name, user identification number). In some implementations, the message may include information about an event. The message may identify a workflow to be executed in response to the event. For example, the message may include an identifier of a workflow.

In some implementations, the method includes selecting a workflow based on information in the message (step 510). In some implementations, the workflow coordinator 111 as described in reference to FIG. 2 may make the selection. The workflow may be selected based on an identifier of a workflow provided in the message. In some implementations, the workflow may be selected according to the external system 101 sending the message and/or the event. For example, an external system 101 may be associated with a predetermined set of workflows (e.g., credit card company associated with workflows for credit card fraud; hospital associated with workflows for patient queues). The associations may be stored in a memory. The predetermined set of workflows may be retrieved based on the external system's 101 client number.

In some implementations, the event may be analyzed to select a workflow from the set. The event may be parsed for keywords. For example, if a message from a credit card company includes the keyword “fraud,” a workflow for authenticating the credit card's user may be selected. If the message includes the keyword “secondary,” a workflow for obtaining approval from the primary holder of the credit card (e.g., a parent) for a transaction being placed by a secondary holder (e.g., a child) may be selected. In another example, if a message from an on-line retailer includes the keywords “discount promotion,” a workflow for offering the user a discount promotion may be selected. If the message includes the keyword “membership invitation,” a workflow for offering the user membership into a retail club may be selected. In another example, if a message from a restaurant includes the keyword “wait,” a workflow for communicating expected wait times for a table may be selected.

In some implementations, the method may include creating an instance of the workflow (step 515). Workflow definition files for the workflow may be retrieved from one or more workflow definition file stores 145. In some implementations, a workflow definition file loader 113 may retrieve the file(s) from the store(s). The loader 113 may load the files into a workflow engine 112 (e.g., a cache of the workflow engine 112). In some implementations, the workflow engine 112 may create a copy of the workflow definition files to create the workflow instance. In some implementations, the workflow engine 112 may create the workflow instance based on information in the workflow definition files.

An identifier (e.g., a unique identification number) may be assigned to each workflow instance. In some implementations, a log for the workflow instance may be created by, e.g., the logging engine 118 described in reference to FIG. 2. The log may include the instance's identifier. The log may include an entry regarding the instance's time of creation (e.g., start time).

In some implementations, the method may include retrieving information about a user stored in a database (step 520). User profiles may be stored in a third-party server or any other medium as would be understood by one of ordinary skill in the art. User profiles may include the user's name, an identification number assigned to the user by the workflow system 100, the communication channels through which the user has consented to receive communications, and/or the indicia for such channels. In some implementations, user profiles may indicate the communication channels for which the user has explicitly refused consent for contact. For example, a user profile may indicate the user consents to contact via SMS at mobile telephone number 555-555-5555, e-mail at userA@emailprovider.com, and mobile application on his or her smartphone with identification number 1234567. In another example, the user profile may indicate the user will not accept SMS messages, but will accept telephone calls, on his or her provided mobile telephone number.

In some implementations, user profiles may include information about user permissions. For example, a user profile may indicate the user will not consent to any workflow steps that require obtaining the user's geolocation via, e.g., the user's smartphone. In some implementations, user profiles may include information about capabilities of the user's devices. For example, the user profile may indicate that one of the user's mobile computing devices cannot capture images and/or audio files. In another example, the user profile may indicate that the user's mobile computing devices subscribe to wireless data plans.

In some implementations, the method may include transmitting a message based on a step in the workflow to the user (step 525). A workflow engine 112 may execute a step in the workflow instance. The step may require communication with the user. The step may include the content of the message to send to the user. The step may include the communication channel to be used for the message. The workflow engine 112 may retrieve, from the user profile, the user's indicia associated with the communication channel. The workflow engine 112 may create an instruction for a message with the content indicated by the step in the workflow to be sent to the user. The instruction may include the user's indicia, as an address. The workflow engine 112 may send the instruction to the notification engine 120 and/or the logging engine 118. The notification engine 120 may instruct a service provider associated with the communication channel to send the message to the user. The logging engine 118 may log an entry for the workflow instance corresponding to the message.

In some implementations, a step in the workflow indicates the communication channel through which the response to the message shall be received. In some implementations, a response may be accepted through one or more communication channels (e.g., response via SMS messaging, e-mail, interactive voice response, or other communication channel described herein). To ensure that a received communication will be redirected to the correct workflow instance, in some implementations, the method may include associating an indicia of a communication channel for the user with the instance of the workflow (step 530).

For example, a specialized work item may create a correlation between the indicia (e.g., a user's mobile telephone number) and the instance of the workflow (e.g., the instance's identifier). Additional work items may create correlations for indicia for all other communication channels through which the response to the message shall be received.

In another example, a correlation engine 116 of a session manager 115 may create a record for the workflow instance. The correlation engine 116 may store the record in a memory. The record may be retrieved from the memory using the instance's identifier. The correlation engine 116 may include the indicia in the instance's record. In some implementations, the correlation engine 116 may include in the record indicia for all other communication channels through which the response to the message shall be received. In some implementations, the correlation engine 116 may create records for the indicia of the communication channels. The engine 116 may include the workflow instance identifier in each of the records.

In some implementations, the method may include receiving a communication from a user through a communication channel (step 535). An aggregator 205 may receive the communication and direct the communication to the notification engine 120 of the system 100. The notification engine 120 may send the communication to the session manager 115.

In some implementations, the method may include matching the communication with the workflow instance based on a correlation between the workflow instance and the indicia of the communication (step 540). In some implementations, the communication may be parsed by the correlation engine 118, by way of example, to obtain the indicia of the communication channel. The correlation engine 118 may search records associating indicia and workflow instances to retrieve the record corresponding to the indicia. The correlation engine 118 may obtain the workflow instance identifier in the record. The correlation engine 118 may log an entry for the workflow instance corresponding to the received communication. The correlation engine 118 may send the identifier to, e.g., the workflow coordinator 111. The workflow coordinator 111 may send the workflow instance identifier and the received communication to the workflow engine 112.

Based on the identifier received from the workflow coordinator 111, the workflow engine 112 may re-load the workflow instance. In some implementations, the method may include processing the communication according to the step in the workflow. The workflow engine 112 may parse the communication to obtain information needed to execute the step. In some implementations, the method may include executing a step in the workflow according to information in the communication (step 545). The method may re-iterate any of the steps described herein until the all the steps have been executed. In some implementations, the method may obtain one or more results of the workflow instance after the instance completes execution. The workflow engine 112 may transmit the one or more results to the external system 101 that requested the workflow.

### EXEMPLARY WORKFLOWS EXECUTED BY SYSTEMS AND METHODS DESCRIBED HEREIN

### Example 1

A user may arrive at a busy restaurant. If no tables are immediately available, the restaurant host may put the user on a waiting list for a table. If the user has previously registered for the workflow platform service, the restaurant host may instruct the system 100 to execute a workflow that informs the user of his or her remaining expected wait for a table every 10 minutes. The workflow engine 112 retrieves workflow definition files for the workflow. The engine 112 detects that steps in the workflow require receipt of SMS messages from the user's mobile telephone number. The correlation engine 118 creates a correlation between the user's mobile telephone number and the identifier of a workflow instance.

As the workflow engine 112 executes the workflow instance, every 10 minutes, the notification system 120 sends an SMS message to the user's mobile telephone number with the remaining expected wait for a table. The SMS message also asks if the user wishes to continue waiting. The user may send a response via SMS. The correlation engine 118 parses the mobile telephone number from the response, matches the response to the workflow instance, and returns the identifier to the workflow engine 112.

If the user does wish to continue waiting, the system 100 sends an SMS message to the user's mobile telephone number in another 10 minutes with the updated wait time. If the user does not wish to continue waiting, the workflow engine 100 may halt and/or abort the workflow instance. If the system 100 does not receive a response within a predetermined period of time (e.g., 2 minutes), the system 100 may halt and/or abort the workflow instance

### Example 2

A user may take an international business trip and remain in the city for a few days of vacation. The user may neglect to tell his or her credit card company of plans to go abroad. The user may attempt to make a major purchase. When the sales staff requests approval of the credit card transaction, the credit card company flags the activity as suspicious. The credit card company requests the system 100 to execute a workflow to detect fraud. The credit card company sends the system 100 the user's identification number, the amount of the attempted purchase, and the city in which the purchase is being attempted.

The workflow engine 112 selects a fraud workflow associated with the credit card company and creates a workflow instance. The workflow engine 112 retrieves the user's profile from a database, which includes the user's mobile telephone number. The workflow engine 112 analyzes the workflow instance and detects that for at least one step, a response via SMS message on a mobile telephone number will be expected. The correlation engine 118 creates a correlation between the workflow instance and the user's mobile telephone number.

The workflow engine 112 instructs the notification engine 120 to send an SMS message to the user's mobile telephone number. The SMS message asks if the user is attempting to make a purchase of the detected amount, in the detected city. The SMS message may request a “yes” or “no” response. The correlation engine 118 correlates any response from the user with the workflow instance. If the user sends back an SMS message with a “yes” response, the workflow engine 112 determines the credit card transaction should be authorized. The workflow engine 112 completes execution of the workflow instance. The workflow engine 112 instructs the workflow request engine 105 to send a message to the credit card company indicating the transaction should be authorized. The workflow engine 112 may store the result of the workflow instance with the workflow definition file store 145.

If the user sends back an SMS message with a “no” response or fails to send a response within a predetermined period of time, the workflow engine 112 determines that credit card fraud has occurred and the transaction should be denied. The workflow engine 112 completes execution of the workflow instance. The workflow engine 112 instructs the workflow request engine 105 to send a message to the credit card company indicating the transaction should not be authorized. The credit card company may deny the transaction and/or cancel the credit card.

### Example 3

A user may be dining in a restaurant when the waiter offers an enjoyable new wine. The user decides he or she would like to purchase three bottles for an upcoming dinner party. Using a camera on a smartphone, the user captures an image of the bottle barcode and/or label. The user sends the image to the system 100 with the message “local wine retailers.” Based on these keywords, the workflow manager 110 selects a workflow for identifying bottles of wine and local purchasing opportunities. The workflow engine 112 executes an instance of the workflow.

The workflow engine 112 invokes an image processing engine for identifying vintages based on wine bottle labels and/or barcodes. The image processing engine analyzes the bottle label image and/or the barcode the user sent and identifies the vintage. The workflow engine 112 invokes a geolocation engine to obtain the user's current location. The geolocation engine communicates with the user's smartphone, whose identification number is provided in the user's profile and thus, correlated with the workflow instance. The smartphone uses a global positioning service (GPS) to obtain its geographical coordinates. The smartphone sends the coordinates to the geolocation engine.

The workflow engine 112 communicates with wine retailers within a 20-mile radius of the user's geographical coordinates. The engine 112 may communicate electronically with the retailers' inventory systems to see if any of the retailers have the vintage in stock. The engine 112 may obtain the retailer's prices. The engine 112 may assemble the information for display on a mobile application on the user's smartphone. Thus, when the smartphone beeps, the user may open the wine retailer mobile application. The mobile application may list the wine retailers with the vintage in stock, the prices at each retailer, and driving directions to each retailer.

To make a purchase, the user may select a retailer. The user may select a number of bottles. As the user places the order, the mobile application sends a payment request to the workflow engine 112. The workflow engine 112 invokes a payment engine, which retrieves credit card information in the user profile and processes the payment to the retailer. When the retailer confirms the transaction, the workflow engine 112 instructs the notification engine to send an e-mail message to the user confirming the purchase. The workflow engine 112 may also provide a confirmation of purchase screen on the mobile application.

After dinner, the user may drive to the wine retailer. By showing the e-mail message or mobile application screen with the confirmation of purchase to the store clerk, the user may pick up the bottles of wine already purchased.

While various embodiments of the methods and systems have been described, these embodiments are exemplary and in no way limit the scope of the described methods or systems. Those having skill in the relevant art may effect changes to form and details of the described methods and systems without departing from the broadest scope of the described methods and systems. Thus, the scope of the methods and systems described herein should not be limited by any of the exemplary embodiments and should be defined in accordance with the accompanying claims and their equivalents.

What is claimed is:

1. A method comprising:
receiving a communication from a user through a first communication channel;
matching, by a processor on a server, the communication with a workflow based on a correlation between the workflow and an indicia associated with the first communication channel and the user; and
processing the communication according to a first step in the workflow.

2. The method of claim 1, wherein the indicia associated with the first communication channel and the user is an e-mail address, a mobile phone number, a uniform resource locator (URL), an internet protocol (IP) address of a computing device, an identification number of a computing device, or an identifier associated with single sign-on (SSO).

3. The method of claim 1, further comprising:
selecting a first communication channel from a plurality of communication channels in a user profile according to the first step in the workflow; and
creating a correlation between the workflow and the indicia associated with the first communication channel and the user.

4. The method of claim 3, wherein selecting a first communication channel further comprises:
configuring an interface according to the first step in the workflow, the interface being accessible via the first communication channel.

5. The method of claim 3, further comprising:
receiving the user profile from a database of user profiles.

6. The method of claim 3, further comprising:
transmitting a communication to the user through the first communication channel according to the first step in the workflow.

7. The method of claim 3, further comprising:
transmitting a communication to the user through a second communication channel according to the first step in the workflow.

8. The method of claim 1, further comprising:
receiving a message with information about an event;
creating a workflow based on the event; and
transmitting a message regarding the processing of the communication from the user to a sender of the message with information about the event.

9. The method of claim 8, wherein creating a workflow further comprises:
loading a workflow definition file into a workflow manager.

10. The method of claim 1, further comprising:
deleting the correlation between the workflow and the indicia associated with the first communication channel and the user in response to a determination that remaining steps in the workflow do not use the first communication channel.

11. The method of claim 1, wherein receiving a communication from a user further comprises:
receiving a communication from an aggregator.

12. A system comprising:
a processor; and
a memory, the memory storing instructions that, when executed by the processor, cause the processor to:
receive a communication from a user through a first communication channel;
match the communication with a workflow based on a correlation between the workflow and an indicia associated with the first communication channel and the user; and
process the communication according to a first step in the workflow.

13. The system of claim 12, wherein the memory further stores instructions that, when executed by the processor, further cause the processor to:
select the first communication channel from a plurality of communication channels in a user profile according to the first step in the workflow, and
create a correlation between the workflow and the indicia associated with the first communication channel and the user.

14. The system of claim 13, wherein the memory further stores instructions that, when executed by the processor, further cause the processor to:
receive a user profile from a database of user profiles.

15. The system of claim 12, wherein the memory further stores instructions that, when executed by the processor, further cause the processor to:
transmit a communication to the user through the first communication channel or a second communication channel according to the first step in the workflow.

16. The system of claim 12, wherein the memory further stores instructions that, when executed by the processor, further cause the processor to:
receive a message with information about an event;
create a workflow based on the event; and
transmit a message regarding the processing of the communication from the user to a sender of the message with information about the event.

17. The system of claim 16, wherein the memory further stores instructions that, when executed by the processor, further cause the processor to:
create the workflow by loading a workflow definition file.

18. The system of claim 12, wherein the memory further stores instructions that, when executed by the processor, further cause the processor to:
delete the correlation between the workflow and the indicia associated with the first communication channel and the user in response to a determination that remaining steps in the workflow do not use the first communication channel.

19. A method comprising:
receiving a message with information about an event;
creating a workflow based on the event;
receiving a user profile from a database of user profiles;
selecting, by a processor on a server, a first communication channel from a plurality of communication channels in the user profile according to a first step in the workflow;
creating a correlation between the workflow and an indicia associated with the first communication channel and the user;
receiving a communication from a user through the first communication channel;
matching the communication from the first communication channel with the workflow based on the correlation between the workflow and the indicia associated with the first communication channel and the user;
processing the communication from the first communication channel according to the first step in the workflow;
selecting a second communication channel from the plurality of communication channels in the user profile according to a second step in the workflow;
creating a correlation between the workflow and an indicia associated with the second communication channel and the user; and
transmitting a communication according to the second step in the workflow to the user through the second communication channel.
